(19) United States
(12) Patent Application Publication
(10) Pub. No.: US 2008/0010194 A1
(43) Pub. Date: Jan. 10, 2008

(54) Method and apparatus for financing community expenses

(75) Inventor: Vincent P. Thomas, Royal Oak, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Automated Payment Highway, Inc., Troy, MI (US)

(21) Appl. No.: 11/483,993

(22) Filed: Jul. 10, 2006

(51) Int. Cl. G06Q 40/00

(52) U.S. Cl. 705/39

(57) ABSTRACT

A method (400, 500, 600) and apparatus for financing community expenses is disclosed. According to an embodiment, the method (400, 600) includes the steps of providing (S.408, S.509, S.609) to a virtual treasurer (100) one or more amounts to be paid to one or more payees (46) and requesting (S.410, S.512, S.615) that the virtual treasurer (100) move a designated amount of funds from a fund account (112a-112c) of each member (102a-102c) of a community (102) to the one or more payees (46). According to an embodiment the method (500) includes the steps of moving (S.508) funds from a fund account (112a-112c) of each member (102a-102c) of a community (102) to a community expense deposit account of a virtual treasurer (100), providing (S.509) to the virtual treasurer (100) one or more amounts to be paid to one or more payees (46), and requesting (S.512) that the virtual treasurer (100) move a designated amount of funds from the community expense deposit account to the one or more payees (46). According to an embodiment, the apparatus includes payee end (16) including one or more payee fund accounts (44), a community end (12) including one or more fund accounts (26) of each member (28) of a community (30), and a provider end (14) that moves a designated amount of funds from the one or more fund accounts (26) of each member (28) of the community (30) to the one or more payee fund accounts (44) of one or more payees (46).

### FIELD OF THE INVENTION

The disclosure relates to a method and apparatus for processing financial data and, more particularly, to a method and apparatus for processing financial data related to community expenses.

### DESCRIPTION OF THE RELATED ART

The handling finances for a group of individuals (i.e., “a community”) is a significant responsibility. A person who oversees the handling of finances for a community may be referred to as a treasurer. Often, a treasurer may be appointed or elected to a position financial responsibility by an organized community (i.e., a community having an established code-of-conduct, rules, by-laws, and the like), such as, for example, a Greek fraternity/sorority, that share “community expenses” (e.g., chapter dues/fees sent to national headquarters, group events including dances, retreats, trips, and the like). In other circumstances, a treasurer may be formally or informally appointed to a position of financial responsibility from within an unorganized community (i.e., a community having no established code-of-conduct, no rules, no by-laws, and the like), such as, for example, roommates/domestic partners, that share “community expenses” (e.g., mortgage/rent, utilities, food, and the like). The “community expenses” may also be referred to as goods/services.

Referring to FIG. 8, a conventional method for managing financial responsibilities of a community is shown generally at 800. A community 801 is shown including a group of roommates 801a-801c residing within living quarters 802 (e.g. a house, apartment, condominium, dorm room, or the like). The conventional method 800 typically operates on the principle that one or more of the roommates 801a-801c (such as, e.g., roommate 801b) is/are financially responsible for one or more bill(s), and, that the other roommates 801a-801c (such as, e.g., roommates 801a, 801c) compensate an appropriate amount to the roommate who is financially responsible for the bill(s).

The term “financially responsible” may be defined to mean that one of the roommates 801a-801c may take charge for a bill in his/her name; that is, according to the illustrated method 800, the roommate 801b may, for example, register cable/Internet services in his/her name. Accordingly, a lack of payment for services rendered by the cable/Internet company may result in a negative credit rating in the name of the roommate 801b, should the cable/Internet service bill not be paid.

As such, according to the illustrated example, the roommate 801b is designated as a “roommate treasurer” and assumes financial responsibility for bills related to goods/services 803 that all of the roommates 801a-801c share/consume. According to the illustrated diagram, examples of goods/services 803 that the roommates 801-801c share/consume, include, for example, mortgage/rent, electricity, gas, water, food, cable television services, Internet services, phone services, and the like.

According to the illustrated example, the roommates 801a, 801c provide compensation 804a, 804c in the form of cash, check, money order, or the like to the roommate treasurer 801b. As such, the collected compensation 804a, 804c, as well as the treasurer's funds are then subsequently transferred to one or more payees 805.

The conventional method 800 may have several drawbacks. If such financial responsibility demands placed upon the treasurer 801b are not managed properly, the roommates 801a-801c may, in a worse-case scenario, be evicted from the living quarters 802. Additionally, the roommates 801a-801c may lose some or all of the goods/services 803 provided by the payee(s) 805.

In some circumstances, the treasurer 801b may face interpersonal problems regarding the cooperation of receiving compensation 804a, 804c from the roommates 801a, 801c. For example, one or more of the roommates 801a, 801c may have inadequate funds in his/her personal checking/savings account and thereby pass a bad check 804a, 804c to the treasurer 801b. When a bad check 804a, 804c is passed, inadequate funds may be deposited in the treasurer's checking/savings account, and, as a result, adequate funds may not be available to pay the payee(s) 805. As such, the financial institution of the roommate treasurer 801b may impose fines and/or overdraft charges as a result of a bad check 804a, 804c being passed by one of his/her roommates 801a, 801c.

In other circumstances, one or more of the roommates 801a, 801c may completely neglect providing any compensation 804a, 804c to the roommate treasurer 801b, and, as such, the roommate treasurer 801b is “stuck” with paying for the consumption of goods/services 803 by one or more of the roommates 801a, 801c. As such, aside from the pressures and responsibility of being the treasurer 801b, animosity and divisions may be fostered between the roommates 801a-801c when compensation 804a, 804c and inter-personal relationships are intertwined.

Thus, even if the treasurer 801b is financially responsible, the financial irresponsibility of others (e.g., roommates 801a, 801c) may impair inter-personal relationships, or, even further, damage the credit rating/result in fees and/or overdraft charges to the treasurer 801b should inadequate funds in a checking/savings account and/or payment of one or more bills to the payee(s) 805 lapse.

Conversely, when a financially-irresponsible treasurer 801b oversees the finances for a community 801, the treasurer 801b may upset the successful operation of the community 801/organization. For example, if a treasurer 801b embezzles community compensation 804a, 804c that was intended for a group dance or group trip, the community 801 may suffer as a whole due to the dishonesty of the treasurer 801b.

Accordingly, a need therefore exists for removing, or, in some circumstances, dispersing the burdens and financial responsibilities placed on an individual 801b associated with the management of payment(s) for goods/services consumed by a community 801. As such, the invention aims to remove and/or disperse financial responsibility burdens placed on an individual 801b.

### SUMMARY OF THE INVENTION

A method and apparatus for financing community expenses is disclosed. According to an embodiment, the method includes the steps of providing to a virtual treasurer one or more amounts to be paid to one or more payees and requesting that the virtual treasurer move a designated amount of funds from a fund account of each member of a community to the one or more payees.

According to an embodiment the method includes the steps of moving funds from a fund account of each member of a community to a community expense deposit account of a virtual treasurer, providing to the virtual treasurer one or more amounts to be paid to one or more payees, and requesting that the virtual treasurer move a designated amount of funds from the community expense deposit account to the one or more payees.

According to an embodiment, the apparatus includes payee end including one or more payee fund accounts, a community end including one or more fund accounts of each member of a community, and a provider end that moves a designated amount of funds from the one or more fund accounts of each member of the community to the one or more payee fund accounts of one or more payees.

### BRIEF DESCRIPTION OF THE DRAWINGS

Embodiments of the disclosure will now be described, by way of example, with reference to the accompanying drawings, wherein:

FIG. 1 is a representative view of a method for financing community expenses according to an embodiment;

FIG. 2A is a representative view of a method for financing community expenses according to an embodiment;

FIG. 2B is a representative view of a method for financing community expenses according to an embodiment;

FIG. 3 is a representative view of a method for financing community expenses according to an embodiment;

FIG. 4 is a flow chart illustrating a method for financing community expenses according to an embodiment;

FIGS. 5A-5B is a flow chart illustrating a method for financing community expenses according to an embodiment;

FIGS. 6A-6C is a flow chart illustrating a method for financing community expenses according to an embodiment;

FIGS. 7A-7E are representative views that illustrate Internet web-site pages for operating the method according to an embodiment; and

FIG. 8 is a representative view of a conventional method for managing financial responsibilities of a community.

### DETAILED DESCRIPTION OF THE INVENTION

Referring now to the drawings, the preferred illustrative embodiments of the present disclosure are shown in detail. Although the drawings represent some preferred embodiments of the present disclosure, the drawings are not necessarily to scale and certain features may be exaggerated to better illustrate and explain the present disclosure. Further, the embodiments set forth herein are not intended to be exhaustive or otherwise limit or restrict the disclosure to the precise forms and configurations shown in the drawings and disclosure in the following detailed description.

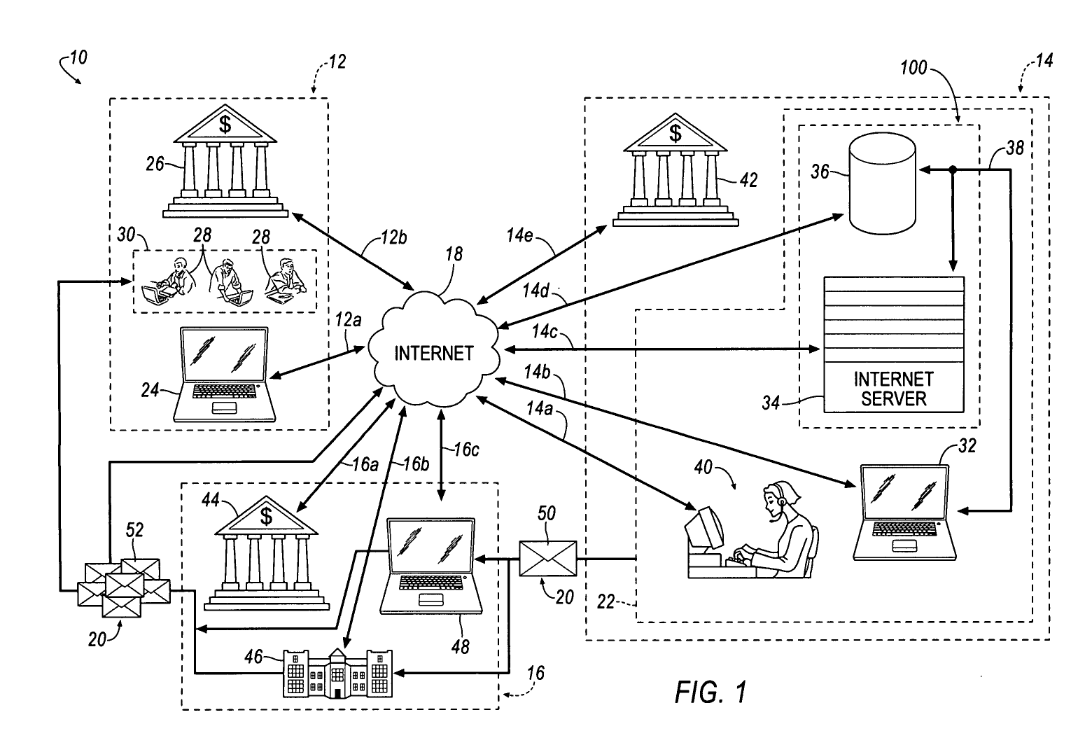

Referring to FIG. 1, a representative view of an apparatus and method for financing community expenses is shown generally at 10 according to an embodiment. The apparatus and method 10 includes a community end 12, a provider end 14, and a payee end 16. The payee end 16 may include, for example, an individual, business, organization 46, or the like that provides goods/services to the community end 12. The community end 12 may be one or more individuals 28 that subscribe to services provided by the provider end 14. The services provided to the community end 12 by the provider end 14 is a “virtual treasurer” 100 that collects and transfers funds from the community end 12 to the payee end 16 to compensate the payee end 16 for goods/services provided to the community end 12.

According to an embodiment, communication between the community end 12, provider end 14, and payee end 16 may take place over the Internet 18 through communication links generally designated at 12a-12b, 14a-14e, and 16a-16c. Alternatively, according to an embodiment, if desired, communication between the community end 12, provider end 14, and payee end 16 may take place over, for example, hand-delivered “snail mail” or a public switched telephone network (PSTN). As illustrated, for example, hand-delivered mail 20 may be communicated from a provider 22, or, alternatively, an agent or representative of the provider 22 of the provider end 14 to the payee end 16 vis-à-vis hand-delivered mail 20 having adequate postage.

According to an embodiment, the community end 12 may include one or more computer workstations 24 that communicate with one or more financial institutions 26 including one or more fund accounts associated with one or more of members 28 of a community 30. According to an embodiment, members 28 of the community 30 may deposit and/or transfer funds to their respective fund account at the one or more financial institutions 26 by appropriately programming the workstation 24 with instructions to be communicated to the one or more financial institutions 26 over the Internet 18.

According to an embodiment, the provider end 14 may include one or more computer workstations 32 that communicates with an Internet server 34 and/or database 36. Communication between the one or more computer workstations 32 and Internet server 34/database 36 may take place over a wired/wireless network 38 in a brick-and-mortar location, or, alternatively, over the Internet 18. According to an embodiment, the brick-and-mortar location may be generally referenced as, for example, the provider 22. Although the Internet server 34/database 36 may be located proximate to a workstation 32 in the provider 22, it will be appreciated that the Internet server 34 and/or database 36 may be remotely located from the provider 22 for security purposes in the event of a fire, earthquake, or the like, which may otherwise destroy information stored on the Internet server 34 and/or database 36.

The provider 22 may also include, if desired, a call center 40 to verbally service stakeholders from, for example, the community end 12 and/or payee end 16. The provider 22 at the provider end 14 may also establish one or more community expense deposit accounts with a financial institution 42 for the depositing, withdrawing, and/or transferring of funds to/from one or more financial institutions 26, 44 associated with the community end 12 and payee end 16, respectively. However, it will be appreciated, that the apparatus and method 10 may be operated without a provider end financial institution 42 and that the provider end 14 may directly transfer funds from the one or more financial institutions 26 of the community end 12 to the one or more financial institutions 44 of the payee end 16.

It will be appreciated that if a financial institution 26, 42, 44 of any one of the community end 12, provider end 14, and/or payee end 16 are one-in-the-same, funds may be simply transferred from one fund account to another within the same financial institution 26, 42, 44. As such, although the illustrated embodiment shows three financial institutions 26, 42, 44 respectively associated with each of the community end 12, provider end 14, and payee end 16, it will be appreciated that the apparatus and method 10 may include one financial institution and that the financial institutions shown generally at 26, 42, 44 may represent a fund account of one or more financial institutions.

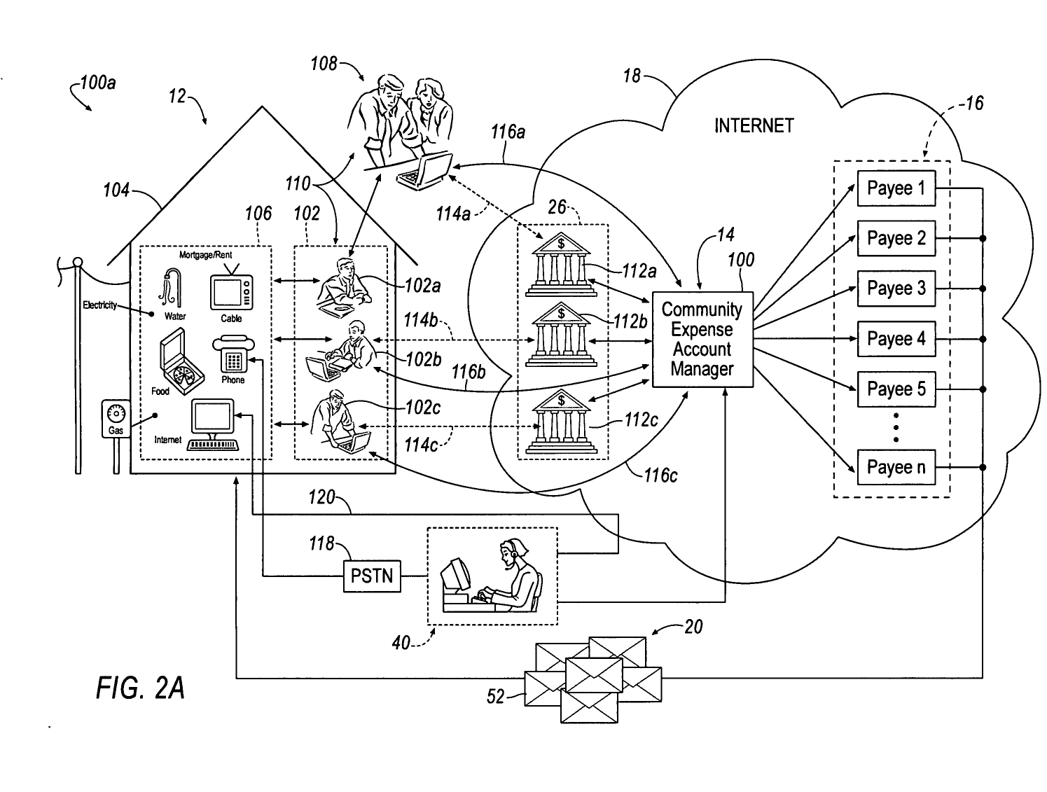

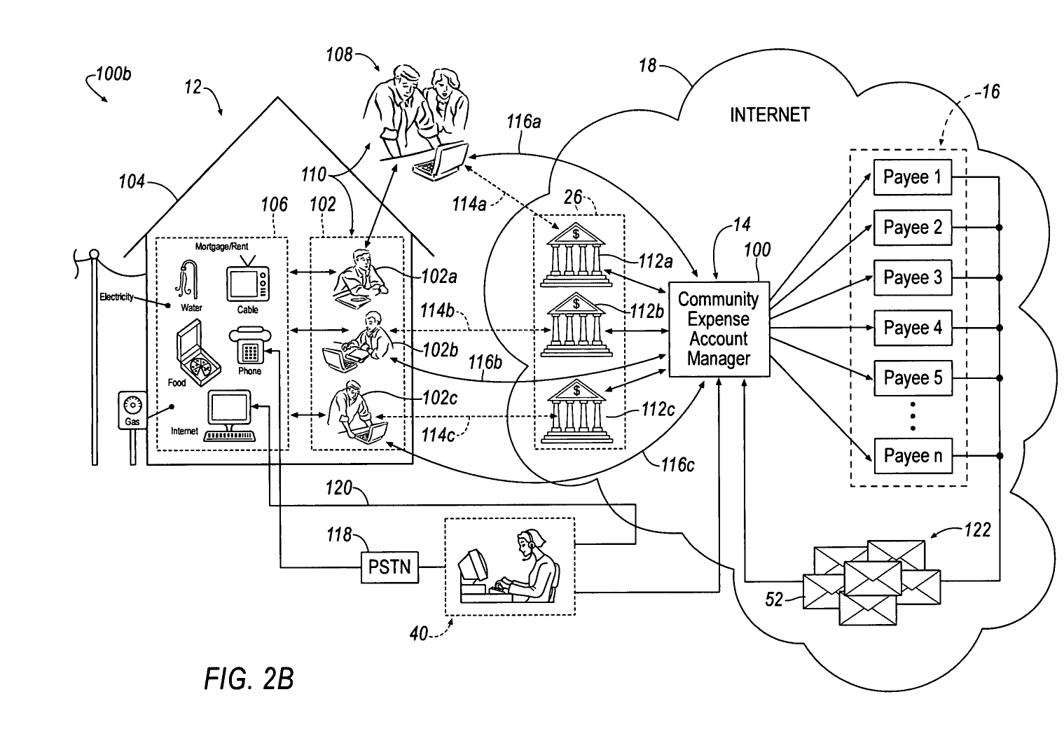

According to an embodiment, the payee end 16 may include a brick-and-mortar location 46 and one or more computer workstations 48 locally or remotely associated with the brick-and-mortar location 46. The financial institution 44 of the payee end 16 may include one or more payee fund accounts that receive funds, over the Internet 18, from one of or both of the financial institutions 26, 42 associated with the community and provider ends 12, 14, respectively. Alternatively, the organization 46 may receive a check 50 from the provider 22/financial institution 42 vis-à-vis hand-delivered mail 20. The payee end 16 may also send bills 52 to the community end 12 vis-à-vis hand-delivered mail 20 (see, e.g., FIG. 2A). Alternatively, if desired, the payee end 16 may send bills 52 to the community end 12 and/or provider end 14 electronically vis-à-vis the Internet 18 (see, e.g., FIG. 2B).

Referring now to FIG. 2A, an apparatus and method for financing community expenses is shown generally at 100a according to an embodiment. The method 100a illustrates a detailed view of the principles discussed in FIG. 1 whereby financial data is processed over the Internet 18 by a virtual treasurer 100 associated with the provider end 14. In FIG. 2A, the community end 12 is represented with members 102a-102c of a community 102. The community end 12 may also include a third party 108 (e.g., parents, a guardian, a relative, a friend, or the like) that funds a portion of community expenses 106 of one or more of the members 102a-102c (e.g., member 102a).

According to an embodiment, the members 102a-102c may be roommates that share consumable community expenses 106. As illustrated, the members 102a-102c share living accommodations 104, such as, for example, a house, apartment, condominium, dorm room, or the like. Additionally, the members 102a-102c may share community expenses 106 (e.g., consumable goods/services), such as, for example, mortgage/rent, electricity, gas, water, food, cable television, Internet services, phone services, and the like. Other community expenses 106 may include, for example, expenses associated with the living accommodations 104 such as, for example, taxes/insurance and/or repairs/updates including, but not limited to: new furniture, new appliances, paint, a new roof, new windows, landscaping, and the like.

Hereinafter, the members 102a-102c and third party 108 are collectively referred to as clients 110 of the provider end 14. When one of the members 102a-102c or third party 108 is referred to on an individual basis, one of the members 102a-102c or third party 108 may be referred to as a client 110 of the provider end 14.

As illustrated, one or more of the members 102b-102c and/or a third party 108, may access one or more of their fund accounts established with one or more financial institutions 112a-112c including, for example, a personal checking/saving or money-market account of the members 102a-102b and/or third party 108, respectively. Access to such fund accounts 112a-112c over the Internet 18 is commonly referred to as “online banking” and is shown generally at communication paths 114a-114c.

Communication paths 116a-116c are also shown extending from the clients 110 that provide the clients 110 with access to a virtual treasurer 100/community expense account manager. Accordingly, it will be appreciated that one or more of the clients 110 may, at any time, have access to the virtual treasurer 100/community expense account manger, vis-à-vis, for example, the Internet 18.

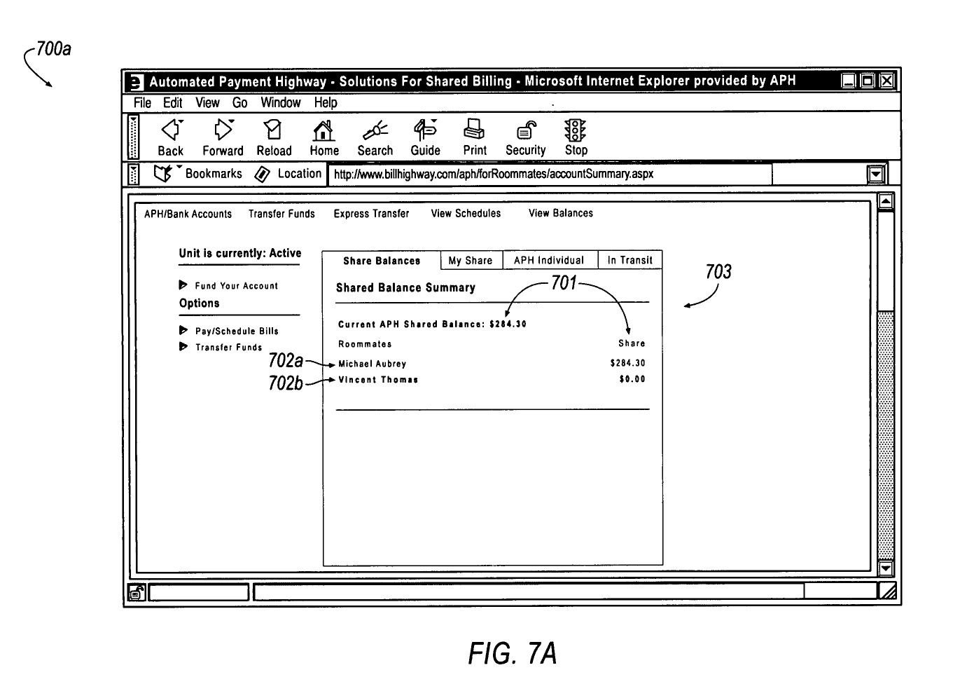

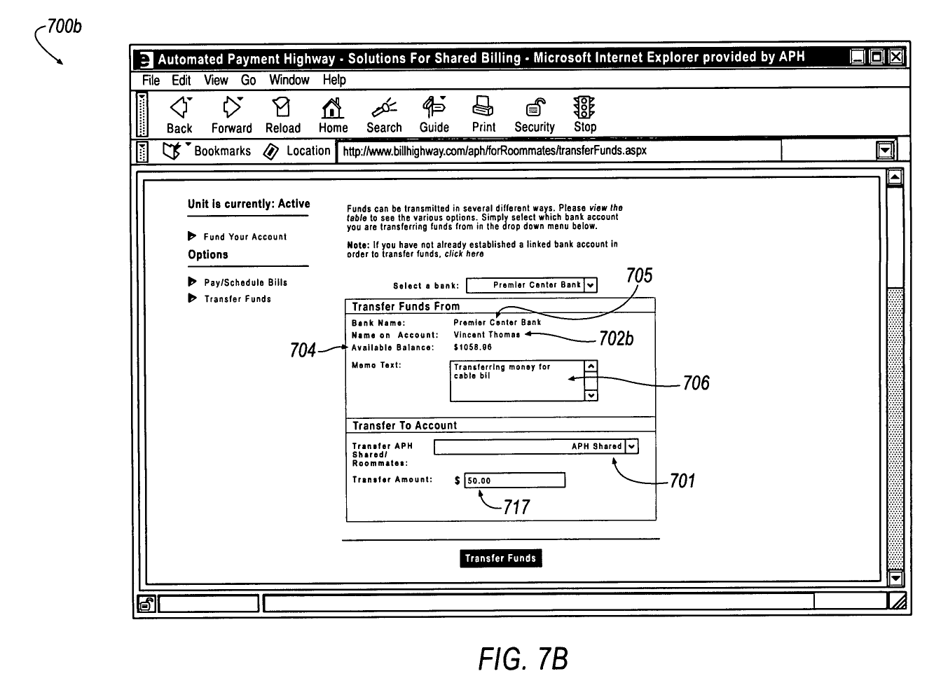

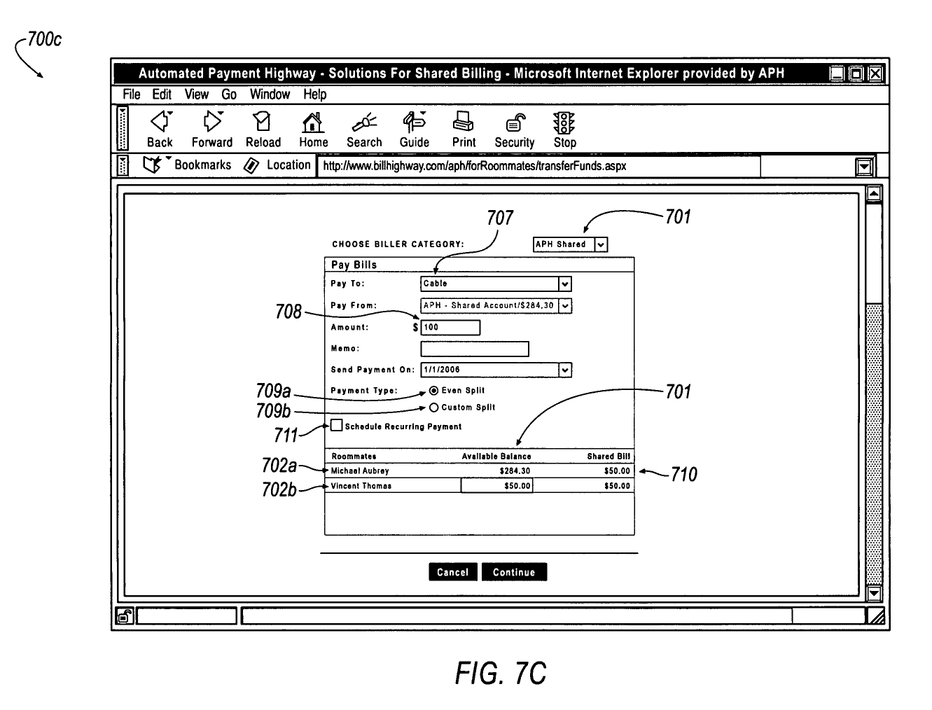

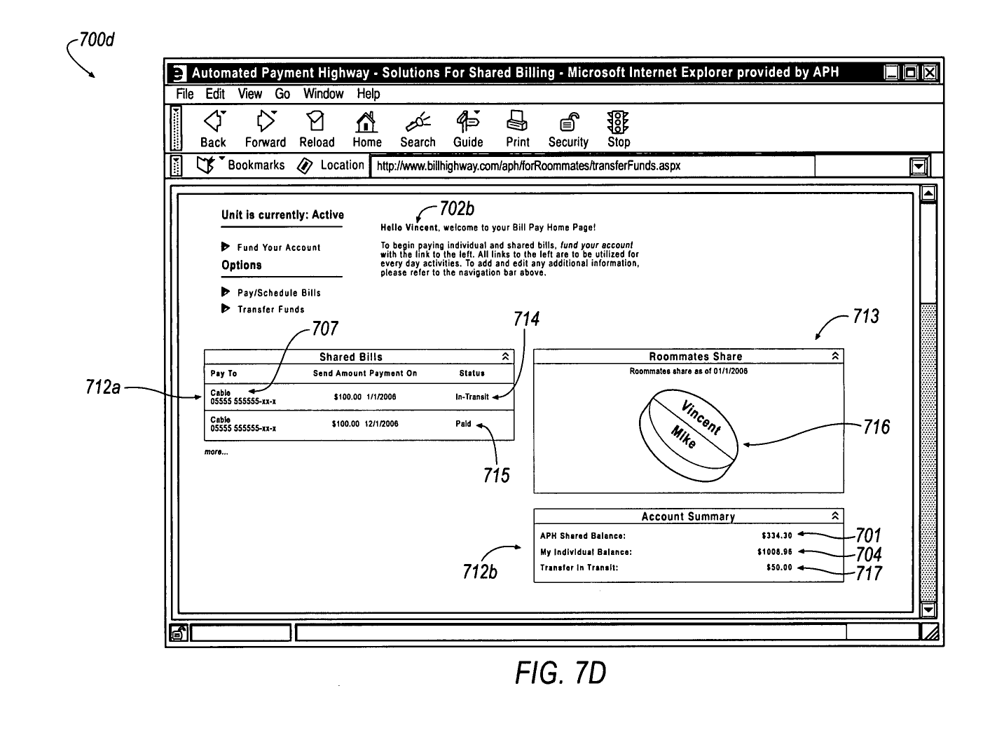

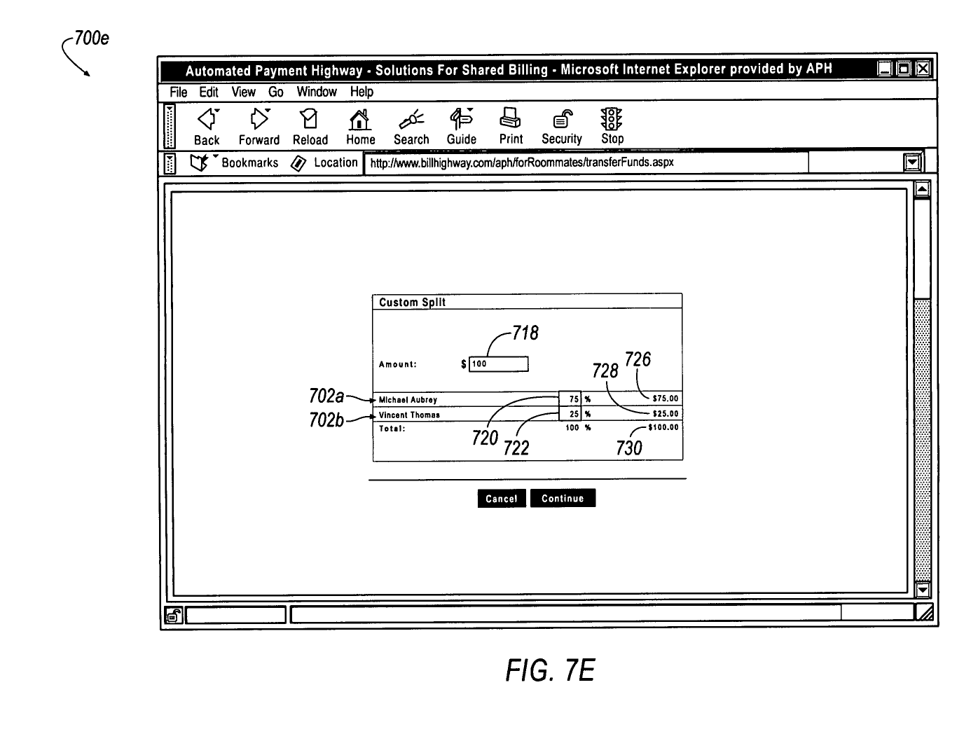

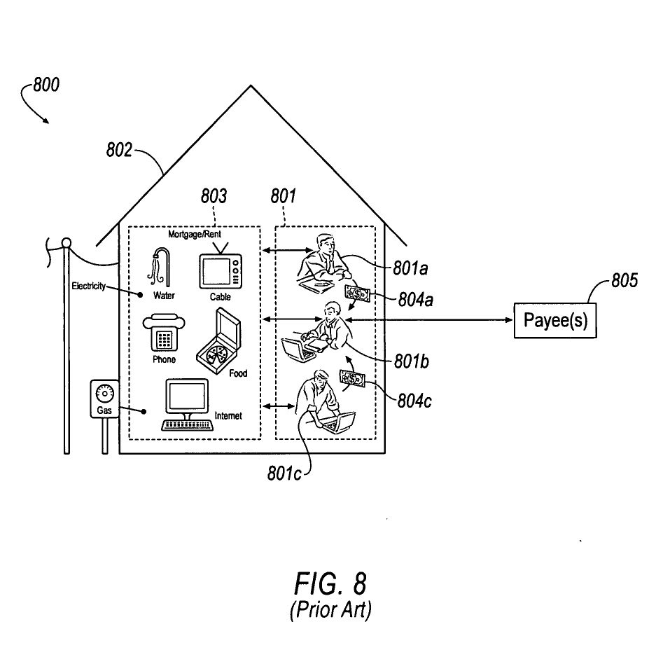

The virtual treasurer 100/community expense account manager is located, for example, at the provider end 14 and, for example, may be owned and operated by the provider 22. The contents of the virtual treasurer 100/community expense account manager may include, for example, Internet web-site pages 700a-700e (see, e.g., FIGS. 7A-7E) that provide a method for financing community expenses 106. The contents of the Internet web-site pages 700a-700e, and data associated with community expenses 106, and/or fund accounts of the clients 110 may be stored on and/or retrieved by the Internet server 34 and/or database 36. Although five web-site pages 700a-700e are shown in FIGS. 7A-7E, the web-site pages 700a-700e are shown for exemplarary purposes and are not meant to limit the number of, or, content of additional web-site pages.

Alternatively, if desired, the clients 110 may communicate with the provider 22 or agent of the provider 22 at the call center 40 vis-à-vis, for example, a PSTN 118 whereby one or more of the clients 110 verbally interacts with the provider 22 or agent of the provider 22 located at the call center 40. The provider 22 or agent of the provider 22 at the call center 40 may access the community expense account manager 100 to view community expenses 106/financial data relating to one or more clients 110 at the one or more financial institutions 26 to verbally assist the clients 110 in the financing of community expenses 106. As such, it will be appreciated that access to the community expense account manager 100 is not limited to a “virtual treasurer environment” over the Internet 18, and, accordingly, may be supplemented with the assistance of one or more live person(s) located at, for example, a brick-and-mortar location 22. It will also be appreciated that the PSTN 118 may be by-passed and verbal communications to/from the clients 110 and the call center 40 may be conducted in a well-known voice-over-Internet peripheral (VoIP) format 120 utilizing the Internet 18.

FIG. 2B generally includes the same aspects described in FIG. 2A except for a difference in the way that bill(s) 52 for good/services are provided from the payee(s) 46. In FIG. 2A, the bill(s) 52 may be sent to the community 102 vis-à-vis hand-delivered mail 20. Conversely, in FIG. 2B, according to an embodiment, bill(s) 52 from the payee(s) 46 may be sent to the community 102 and/or community expense account manager 100 in electronic form 122 vis-à-vis the Internet 18. As such, the apparatus and method 100b of FIG. 2B flattens the method 100a of FIG. 2A by removing the step of providing hardcopies of bill(s) 52 from the payee(s) 46 to the community 102. Thus, time to authorize payment of bill(s) 52 may be reduced and mailing costs of sending paper bill(s) 52 from the payee(s) 46 to the community 102 is reduced. Accordingly, the potential for bill(s) 52 being neglected/lost/misplaced in the hand-delivered mail 20, or, at the site of the living accommodations 104 is eliminated.

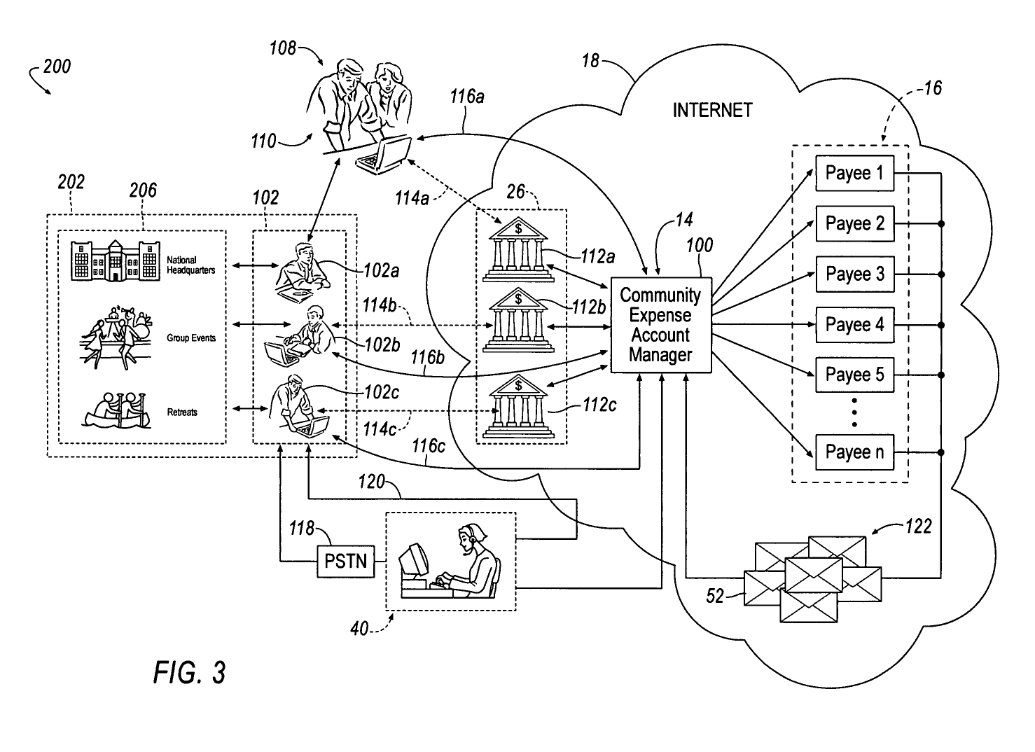

FIG. 3 generally includes the same aspects described in FIGS. 1-2B expect for a difference in relationship of members 102a-102c of the community 102 as well as the community expenses 106 of goods/services consumed by the community 102. The apparatus and method 200 shown in FIG. 3 illustrates a community 202 that represents an organization, such as, for example, a for-profit or non-profit organization. Organizations may include, for example, a Greek fraternity/sorority, an alumni organization, a skilled-trade union, or the like. Community expenses 206 may include, for example, chapter dues/fees to national headquarters, group events including dances, retreats, trips, and the like.

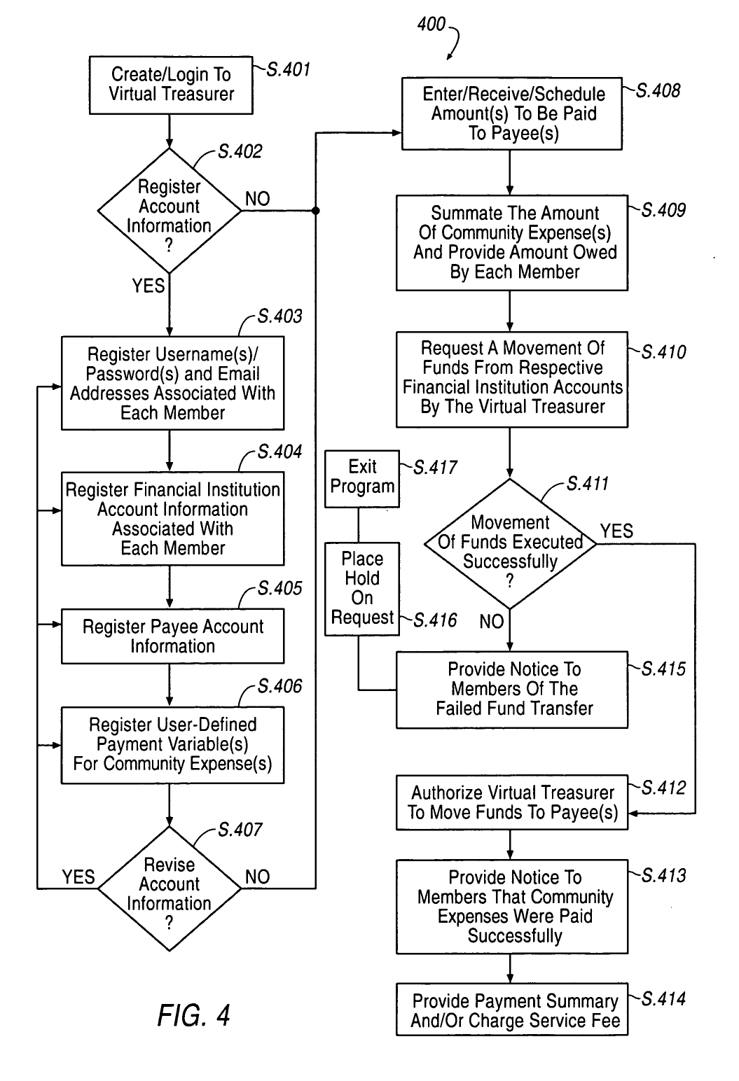

Referring now to FIG. 4, a method for utilizing the virtual treasurer/community expense account manager 100 is shown generally at 400 according to an embodiment. First, at step S.401, a client 110 creates/logs-in to the virtual treasurer 100. At step S.402, the method 400 offers an opportunity to register account information. Account information may include username(s)/password(s) and/or email addresses associated with username(s) that is/are registered at step S.403. Financial institution account information associated with each member 102a-102c is registered at step S.404. Payee account information is registered at step S.405. User-defined custom payment variable(s) relating to community expenses is registered at step S.406. It will be appreciated that additional account information may be entered and that the method 400 is not limited to the enterable information at steps S.403-S.406. At step S.407, an opportunity is given for the client(s) 110 to add and/or revise any of the entered account information at steps S.403-S.406.

At step S.403, for example, a corroboration of an authorized username may be provided for added security measures. After a community expense account is created/issued by the virtual treasurer 100 to a first person (i.e. one of the clients 110), for example, additional username(s)/email addresses associated with additional members 102a-102c/third parties 108 may be added and corroborated by the first person who created the community expense account. For example, when a second username is created/issued for the community expense account, the first person who created the account may corroborate that the additional username(s) is/are authentic and are authorized to gain access to the community expense account by entering his/her password when the newly added username desires to gain access to the community expense account for the first time. Alternatively, requests for additional username(s)/password(s) may be issued by the first person who created the account and/or provider 22; as such, corroboration of additional username(s) by a first person may be omitted.

When financial institution/payee account information is registered at steps S.404, S.405, the virtual treasurer 100 may request, for example, account numbers, routing numbers, addresses and/or phone numbers of the financial institutions 26, 44. The method 400 may provide security measures to limit the exposure of information pertaining to balances in personal checking/savings account(s) of the fund accounts 112a-112c so that such information is only viewable by the owner of the checking/saving fund account 112a-112c. However, security measures may be lifted and access to personal checking/saving fund account information at the financial institutions 26 may be provided by one client 110 to another.

At step S.406, user-defined custom payment variable(s) may include a defined amount owed by one or more or the members 102a-102c of a particular bill 52. For example, if the member 102a takes, on average, two showers a day, and the members 102b and 102c each take, on average, one shower a day, the user-defined customer payment variable for a water bill 52 may require that the member 102a pays 50% of the water bill whereas the members 102b, 102c each pay 25% of the water bill 52. According to another example, the member 102a may never take a shower, and, accordingly, the user-defined customer payment variable for a water bill may be designated such that the member 102a pays 0% of the water bill 52 from his fund account 112a whereas the members 102b, 102c may each pay 50% of the water bill 52 from their fund accounts 112b, 112c if each of the members 102b, 102c determines that they, on average, take the same number of showers. Accordingly, the members 102a-102c may pre-define a specific amount owed by each member 102a-102c for one or more of the bills 52 in view of a proportional amount of a good/service of the community expenses 106 consumed by a particular member 102a-102c.

Based upon the selection by the client 110 from either steps S.402 or S.407, the method 400 is advanced to step S.408. At step S.408, amount(s) to be paid to payee(s) 46 may be entered, received, or scheduled with the virtual treasurer 100. For example, bill(s) 52 may be sent to the community 102 via hand-delivered mail 20 as shown in FIG. 2A, and, accordingly, one of the members 102a-102c may manually program the amount(s) of the bill(s) 52 with the virtual treasurer 100. Alternatively, if a particular bill 52 is the same every month (e.g., the Internet bill is always $35), a member 102a-102c may manually schedule the amount of a particular bill 52 and the day the payment is due for the bill 52 with the virtual treasurer 100. Alternatively, bill(s) 52 may be electronically sent to the community 102 and/or virtual treasurer 100 as shown in FIG. 2B, and, accordingly, bill(s) 52 are automatically received and/or uploaded with the virtual treasurer 100 without the need to manually program or schedule an amount to be paid to a payee 46.

At step S.409, the amount of community expenses 106 are summated, and, if desired, the summated amount may be provided to each client 110 by, for example, an email from the virtual treasurer 100 to an email address associated with each client 110. For example, emails including the an itemized and/or summed amount may be sent as bill(s) 52 are entered/received. According to another embodiment, for example, if two-days are required for a particular bill 52 to clear upon authorization of payment to a payee 46, an itemized or summed amount “owed reminder” for each client 110 may be sent in an email at least two-day prior to a due-date of a bill 52.

At steps S.410 and S.411, one or more of the clients 110 may request a transfer of funds to the payee(s) 46. Alternatively, the virtual treasurer 100 may automatically request a transfer of funds to the payee(s) 46 without a request being placed by one or more of the clients 110. According to an embodiment, at the time of the automatic or issued request, the virtual treasurer 100 may poll the fund accounts 112a-112c associated with each client 110 and extract an amount owed by each client 110 based upon a used-defined custom payment variable from step S.406, or, alternatively, an “even split” based upon the number of members 102a-102c in the community 102.

If adequate funds are available in each of the clients' fund accounts 112a-112c, step S.411 is advanced to step S.412. However, if adequate funds are not available in one or more of the clients' fund accounts 112a-112c, step S.411 is advanced to step S.415 where a notice is provided to the clients 110 that the request for a transfer of funds to the payee(s) 46 has failed. The notice at step S.415 is provided, for example, via email, to an email address associated with each client 110. Additionally, if desired, a hardcopy of the notice is provided via, for example, hand-delivered mail 20 to the clients 110. Step S.415 is advanced to step S.416 where a hold is placed on the fund transfer request so that the client(s) 110 may have adequate time to transfer/provide funds in their respective fund account(s) 112a-112c so that the bill(s) 52 may be paid once the hold at step S.416 is lifted. Alternatively, if desired, the hold at step S.416 may be placed, and the method may be exited at step S.417. Alternatively, if desired, the hold at step S.416 may be obviated if one of the clients 110 volunteers to pay for the bill(s) 52 with available funds from their fund account 112a-112c; as such, late fees and/or a deactivation of a good/service to the community 102 may be obviated if one of the clients 110 takes financial responsibility for another client 110.

If no particular member 102a-102c of the community 102 wishes to take financial responsibility for the financially delinquent member 102a-102c at steps S.411 and S.415, the remaining members of the community 102 who have adequate funds in their fund account 112a-112c may, as a whole, each become a direct stakeholder in dividing the overall financial responsibility of the community 102. Accordingly, the remaining members 102a-102c of the community 102 as a whole may then apply pressure to the delinquent member of the community 102 so that he/she will be urged to pay his/her share of the bills 52. Accordingly, in comparison to prior art methodologies 800, no one person (e.g. roommate treasurer 801b) is “on the hook” for a particular bill 52, and thus, the community 102 as a whole becomes responsible for cooperating in the management of the financing of community expenses 106.

When the method is advanced from step S.411 to step S.412, the virtual treasurer 100 is authorized to pay the payee(s) 46 by transferring/moving funds from the fund accounts 112a-112c associated with each client 110 to one or more financial institution accounts 44 associated with the one or more payee(s) 46. Then, at step S. 413, a notice is sent via, for example, email, to email addresses associated with the clients 110 that community expenses 106 associated with bill(s) 52 were paid to the one or more payee(s) 46.

Then, at step S.414, a payment summary and/or service charge is provided to the clients 110. The payment summary and/or service charge of step S.414 may be provided from the virtual treasurer 100 to the clients 110 on a transactional basis, or, alternatively, on a scheduled basis. For example, service charges may be provided to the clients 110 for each bill 52 that is paid, or, on a weekly basis, or, on a monthly basis, or, as a percentage based upon the amount of the bill(s) 52 that is/are paid to the payee(s) 46.

According to another embodiment, the payment summary at step S.414 may be issued once a year for tax purposes if, for example, the community expenses 106 are related to information appearing on an income tax filing receipt. According to an embodiment, if the members 102a-102c split a mortgage on the living quarters 104, interest paid to a mortgage lender and/or summer/winter tax bills paid to a local government body may be paid vis-à-vis the virtual treasurer 100, and, accordingly, a one-time interest and tax payment summary statement may be provided to each member 102a-102c at step S.414 showing the amount of interest and taxes that were paid by each member 102a-102c in a fiscal year. Accordingly, if an annual grand total of $6000 in interest and $3000 in taxes are paid by the three members 102a-102c, a customized payment summary report may be generated for each member 102a-102c showing that each member 102a-102c paid $2000 in interest and $1000 in taxes for a particular fiscal year. Information pertaining to taxes, insurance, and the like may be manually entered by the clients 110. If taxes, for example, are paid from an escrow account, escrow account information may be provided to the virtual treasurer 100 over the Internet 18.

It will be appreciated that the payment summary report of step S.414 may not be limited to tax-filing information. For example, the payment summary report may be related to one or all bills 52 that are handled by the community expense account manager 100. For example, if the members 102a-102c have to determine a way to reduce community expenses 106, the members 102a-102c may request a payment summary report to determine if the members should reduce expenditures on, for example, food, Internet services, cable television services, phone services, or the like. As such, it will be appreciated that a payment summary report may be requested at any time, on demand, by any of the clients 110 and is not limited to an annual report associated with a tax-filing receipt as discussed above.

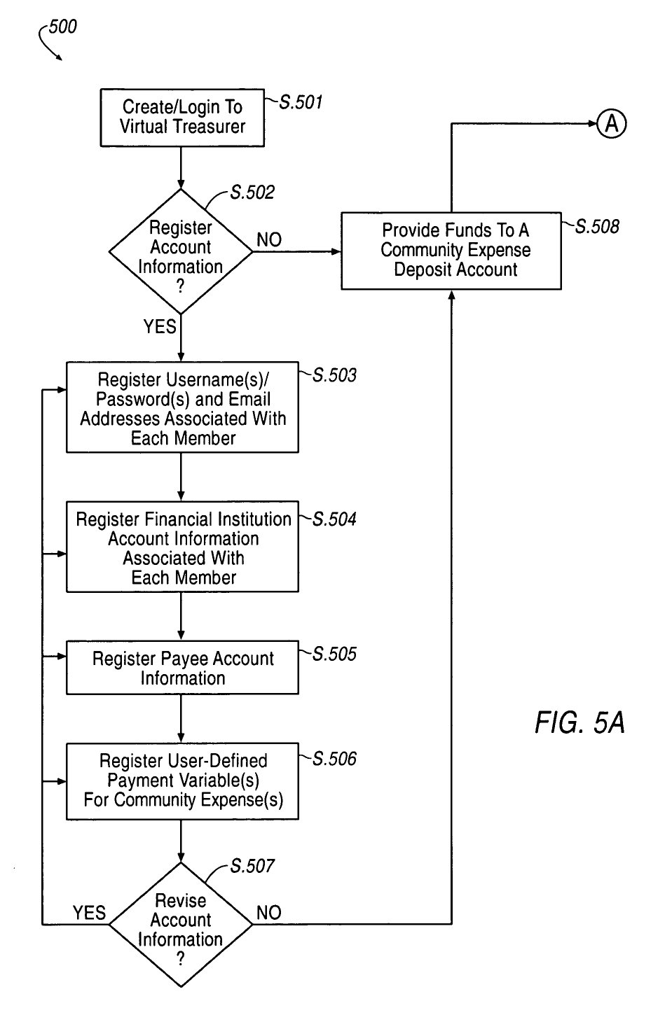

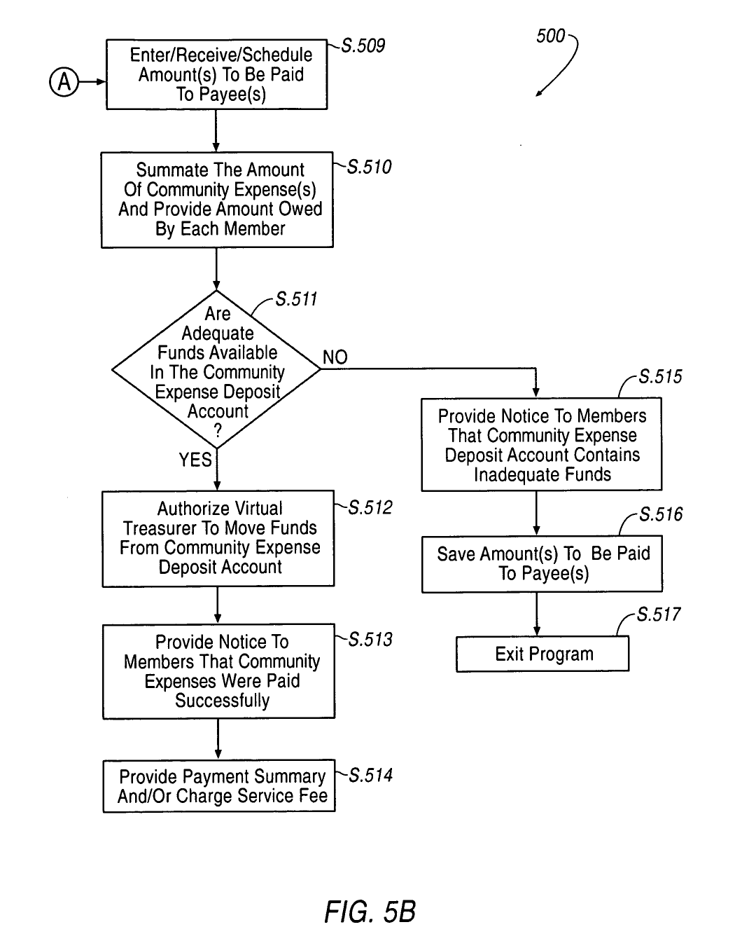

Referring now to FIGS. 5A-5B, a method for utilizing the community expense account manager 100 is shown generally at 500 according to an embodiment. Steps S.502-S.507 are substantially similar to steps S.402-S.407 and are therefore not explained in detail here for purposes of brevity. After either steps S.502 or step S.507, step S.508 offers the clients 110 the opportunity to provide funds to a community expense deposit account. According to an embodiment, the funds provided to the community expense deposit account may be manually or automatically transferred from one or more of the fund accounts 112a-112c associated with clients 110 to a community expense deposit account established at the financial institution 42 associated with the provider end 14. The community expense deposit account may be, for example, a interest-bearing, or, a non-interest-bearing account. If an interest-bearing account, accrued interest may be returned to the clients 110, or, alternatively, to the provider 22 as profit for providing services to the clients 110.

According to an embodiment, the virtual treasurer 100 may require that the clients 110 maintain a minimum balance value in the community expense deposit account in order to utilize the services provided by the virtual treasurer 100. For example, if the summation of monthly bills of the community 102 are, on average, approximately $800 a month, the virtual treasurer 100 may require that the clients 110 maintain at least $1000 in the community expense deposit account to cover monthly bills. Accordingly, in the embodiment shown in FIGS. 5A-5B, the community expense account manger 100 may move funds from the established community expense deposit account to one or more financial institutions 44 associated with the one or more payee(s) 46 rather than polling one or more fund accounts 112a-112c and transferring the funds from the one or more fund accounts 112a-112c to the one or more payee(s) 46 as described in FIG. 4. As such, the movement of funds in the method 500 is simplified in view of the use of a community expense deposit account.

Once the opportunity to provide funds to a community expense deposit account at step S.508 is over, the method 500 is advanced to steps S.509 and S.510, which are substantially similar to steps S.408 and S.409, respectively. Then, at step S.511, the virtual treasurer 100 determines if the amount of the bills 52 summed at step S.510 is available in the community expense deposit account. If the summed amount is available in the community expense deposit account, the method 500 is advanced to step S.512, however, if the summed amount is not available in the community expense deposit account, the method 500 is advanced to step S.515.

At step S.515, a notice is provided to the clients 110, via, for example, an email, that the community expense deposit account contains inadequate funds to pay the bills 52. The method is then advanced to step S.516 where the amount to be paid to the payee(s) 46 is saved by the virtual treasurer 100. Then, at step S.517, the program 500 is subsequently exited. Accordingly, upon receiving a notice that inadequate funds are in the community expense deposit account, one or more of the clients 110 may return to step S.508 to provide adequate funds to the community expense deposit account. Accordingly, as explained above, the method 500 makes each member of the community 102 a direct stakeholder in the financing of community expenses 106 by dividing the overall financial responsibility within the community 102 rather than placing the burden and responsibility on one person.

If, however, funds are available in the community expense deposit account, the method 500 is advanced from step S.511 to steps S.512-S.514, which are substantially similar to steps S.412-S.414. At step S.512, funds are moved from the community expense deposit account to the one or more financial institutions 44 associated with the one or more payee(s) 46 rather than, as in the method 400 of FIG. 4, from the fund accounts 112a-112c associated with the clients 110 in order to pay the payee(s) 46.

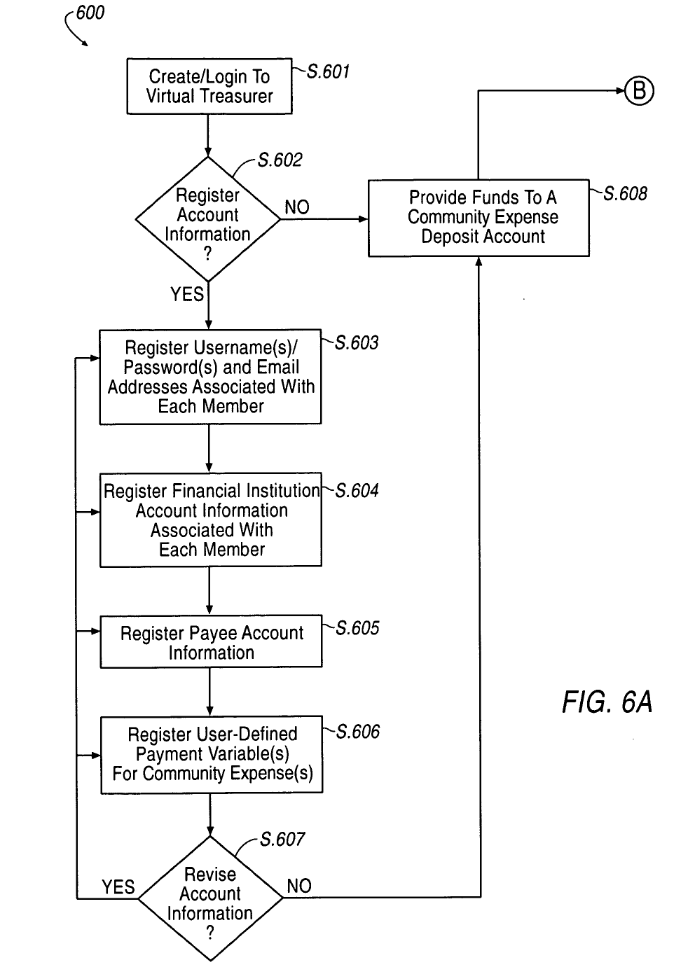

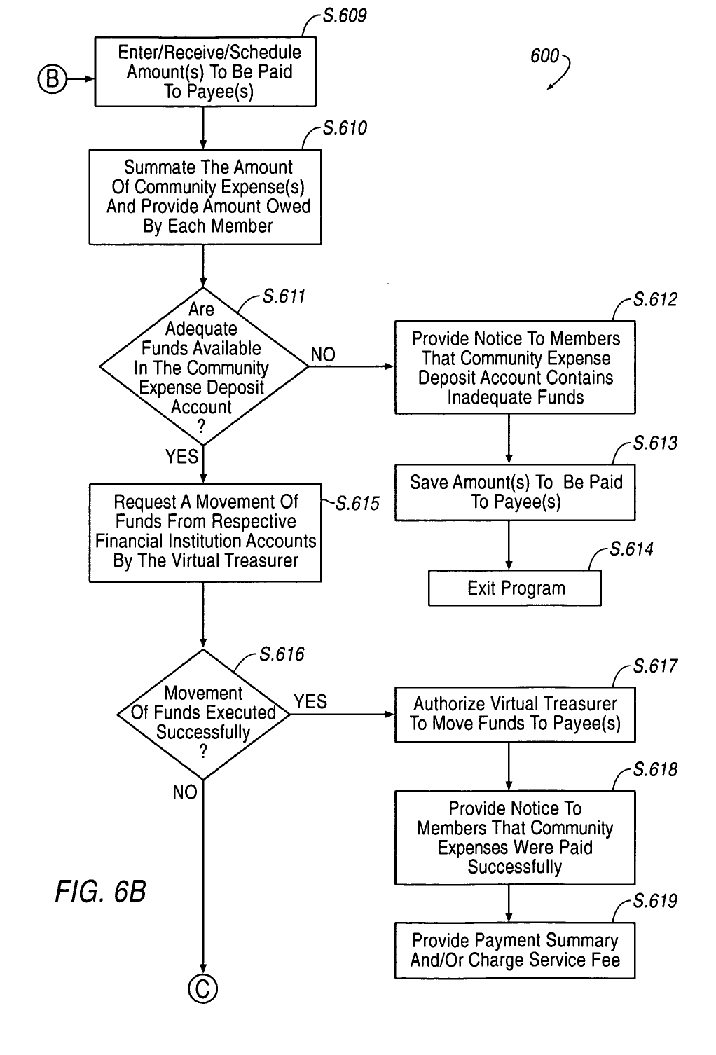

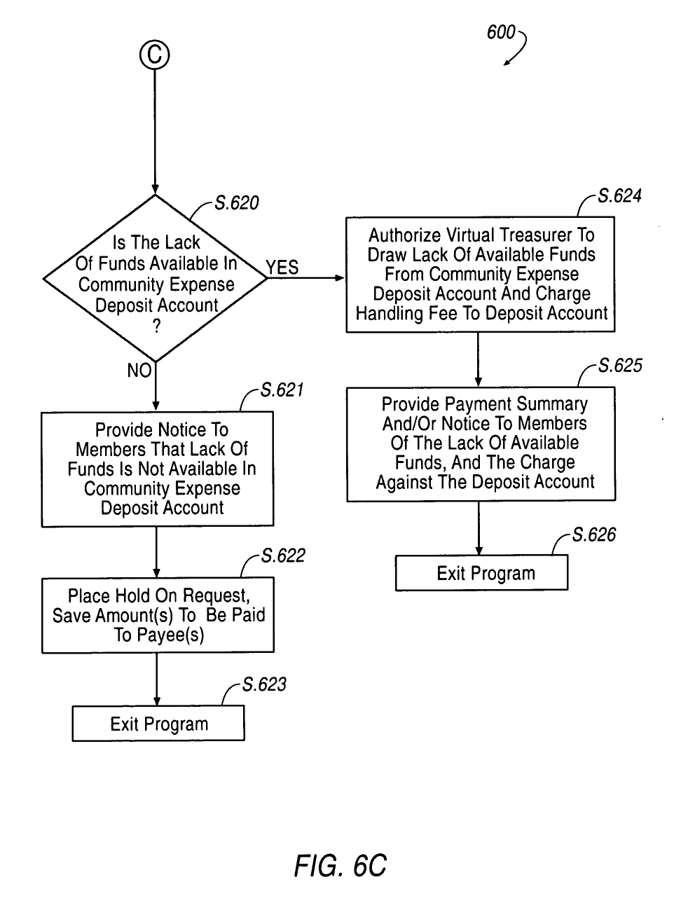

Referring now to FIGS. 6A-6C, a method for utilizing the community expense account manager 100 is shown generally at 600 according to an embodiment. The method 600 combines the features shown in discussed in the methods 400, 500 in that the method 600 utilizes a deposit account (as in the method 500 of FIGS. 5A-5B) while moving funds from the fund accounts 112a-112c of the clients 110 to pay the payee(s) 46 (as in the method 400 of FIG. 4). In operation, the method 600 may provide a safety net in view of the method 400 in that if one or more of the members 102a-102c is delinquent in maintaining a balance in his/her personal fund account 112a-112c, funds that the delinquent member owes is withdrawn from the community expense deposit account and utilized as payment for the delinquent member(s). Steps S.601-S.614 are substantially similar to steps S.501-S.511, S.515-S.517 and are therefore not explained in detail here for purposes of brevity.

If it is determined during the operation of the method 600 that funds are available in the community expense deposit account at step S.611, the method 600 is advanced to steps S.615-S.616, which are substantially similar to steps S.410-S.411. If the transfer of funds is executed successfully at step S.616, the method 600 is advanced to steps S.617-S.619, which are substantially similar to steps S.412-S.414. If however, at step S.616, funds are not available in the respective fund accounts 112a-112c of the clients 110, the method 600 is advanced to step S.620 where it is determined if the lack of available funds is available in the community expense deposit account. If the lack of available funds is not available in the community expense deposit account at step S.620, the method 600 is advanced to step S.621 where a notice is sent to the clients 110 of the lack of available funds in the deposit account as well as the lack of available funds in one or more fund accounts 112a-112c of the clients 110. The method 600 is then advanced to step S.622 where a hold is placed and the amount to be paid to the payee(s) is saved. Then, the method 600 is exited at step S.623.

If however, it is determined at step S.620 that the amount of the lack of funds from one or more of the client's financial institutions 112a-112c is available in the community expense deposit account, the method 600 is advanced from step S.620 to step S.624 where the lack of funds from one or more of the client's fund accounts 112a-112c is drawn from the community expense deposit account. If desired, the virtual treasurer 100 charges a handing fee to the community expense deposit account for executing the transaction at step S.624. The method 600 is then advanced to step S.625 where the virtual treasurer 100 provides a notice to the clients 110, via, for example, email, that the one or more payee(s) 46 was/were paid with funds from the respective financial institutions 112a-112 of the clients 110 and with funds from the community expense deposit account. In addition, the notice may include a message that a handling charge was issued to the community expense deposit account due to the drawing of funds from the community expense deposit account. The method 600 is then advanced to step S.626 where the program is exited.

Referring now to FIGS. 7A-7E, web-site pages for financing community expenses are shown generally at 700a-700e according to an embodiment. According to an embodiment, the website pages 700a-700e operate on the principle of a community expense deposit account described above. The community expense deposit account is shown generally ay 701 and is labeled “APH Shared Balance.” The illustrated embodiment of the web-pages 700a-700e are formatted in manner to include two roommates, which are shown generally at 702a, 702b. APH is an acronym for “Automated Payment Highway,” which may be, for example, the name of the provider 22. APH may be accessed, for example, at www.billhighway.com.

Referring to FIG. 7A, the web page 700a provides a table 703 showing a shared balance summary of a community expense deposit account 701 including funds of the two roommates 702a, 702b. As illustrated, the community expense deposit account may be itemized to show the ownerships of funds in the community expense deposit account. For example, the roommate 702a has a balance of $284.30 in the community expense deposit account 701 and the roommate 702b has a balance of $0.00 in the community expense deposit account 701.

According to the following description, the roommate 702b accesses and programs the web-pages 700a-700e; thus, the web-pages 700a-700e are personalized according to the identity of the roommate 702b at the time of login to the virtual treasurer 100. Because the web-pages 700a-700e are personalized according to the identity of the roommate 702b, fund account information of the roommate 702a may not be made available for viewing by the roommate 702b; accordingly, the roommate 702b may be restricted to only view an amount of funds owned in the community expense deposit account (e.g., $284.30) by the roommate 702a in addition to the personal funds in a funds account 112a-112c of the roommate 702b.

Referring to FIG. 7B, the roommate 702b accesses a “fund your account” web-page 700b where the roommate 702b may transfer funds 717 from a balance 704 in his checking/savings fund account 705 in a financial institution 26 to the community expense deposit account 701 associated with the financial institution 42. A memo field 706 may also be included on the web-page 700b to provide a reminder to the roommate 702b of the particular reason for the transfer of funds 717 from the balance 704 in the fund account 705. According to the illustrated embodiment, the roommate 702b chooses to transfer $50 from his personal checking/savings fund account 705, the balance 704 of which is valued at $1058.96.

Referring to FIG. 7C, the roommate 702b accesses a “pay bill” web-page 700c where the roommate 702b may manually program a payment of a bill 707 from the deposit account 701. According to the illustrated embodiment, the bill 707 to be paid is a cable bill. The roommate 702b may have received a cable bill 707 for $100 (as shown in FIG. 2A), or, the virtual treasurer 100 may have received the cable bill 707 for $100 (as shown in FIG. 2B) and provided the amount of the cable bill 707 in the field box 708. As illustrated, the web-page 700c may include radio buttons 709a, 709b that designate an “even split” of the cable bill 707, or, alternatively, a user-defined “custom split” of the cable bill 707, respectively. Because the “even split” radio button 709a has been selected, the owed amount of the shared cable bill 707 of $100 is evenly divided in a table 710 to show that each roommate 702a, 702b owes $50 apiece. A check box 711 is also included on the web-page 700c to allow the roommates 702a, 702b the option to schedule a recurring payment of the cable bill 707 if it is anticipated that the cable bill 707 will be the same amount every billing period.

Referring to FIG. 7D, the roommate 702b may then access a “bill pay homepage” web-page 700d that provides tables 712a, 712b and/or graphical charts 713 related to finances in one or more community/provider/payee accounts. According to the illustrated embodiment, the web-page 700d provides a view of payment activity/history of one bill, being the cable bill 707 in table 712a. As illustrated, the table 712a shows an “in-transit” bill 714 according to the programmed information from web-page 700c as well as a “paid” bill 715 according to an earlier transaction in the previous billing period. Although one “paid” bill 715 is shown as part of the payment history in the table 712a, it will be appreciated that more than one “paid” bill 715 may be shown in the table 712a if the web-page 700d is customized to show more than one bill 52.

According to an embodiment, the web-page 700d may also include a graphical chart 713 that represents an owed amount of a particular bill, or, an owed amount for a summarization of bills. According to the illustrated embodiment, because one bill is being shown and that the one cable bill 707 was evenly split, the graphical chart 713 shown is in the form of a pie graph 716 that is evenly split in a manner so as to illustrate that each roommate 702a, 702b is responsible for 50% of the cable bill 707.

According to an embodiment, the web-page 700d may also include a table 712b that illustrates finances in the community expense deposit account 701. As explained above, the web-page 700d is customized for viewing by the roommate 702b, and, accordingly, the balance 704 of his checking/savings fund account 705 may be represented in the table 712b as well as an amount 717 that is being transferred from the checking/savings fund account 705 to the community expense deposit account 701. As illustrated, because the roommate 702b transferred $50 from his personal checking/savings fund account 705 to the community expense deposit account 701, the value of his personal checking/savings fund account 705 has been reduced from $1058.96 (as shown in FIG. 7B) to $1008.96 (as shown in FIG. 7D). Additionally, FIG. 7D shows that the balance of the community expense deposit account 701 has increased, by $50, from $284.30 to $334.30. It will be appreciated that the data from the checking/saving fund account 705 may be updated in real time to reflect changes in the checking/saving fund account 705, if, for example, a deposit/withdrawal to the checking/saving fund account 705 has transpired, or, if, for example, the checking/saving fund account 705 is linked to a debit card.

According to an embodiment, the web-page 700e may include fields 718-722 relating a “custom split” of the cable bill 707, should the radio button 709b of FIG. 7C be selected. The field box 718 includes the amount of the cable bill 707 and the field boxes 720, 722 are provided for the roommates 702a, 702b to enter a proportional amount of the cable bill 707 owed by the roommates 702a, 702b. According to the illustrated example, it may be determined that the roommate 702a owes 75% of the cable bill 707 and that the roommate 702b owes 25% of the cable bill 707. Accordingly, the amount owed by each roommate 702a, 702b may be tabulated on the web-page 700e at 726, 728 and a total amount owed may be shown at 730.

The method described in FIGS. 1-7E provide a plurality of tools that removes, or, in some circumstances, disperses the burdens and financial responsibilities placed on an individual associated with the management of the payment(s) for goods/services consumed by a community. As such, the method of FIGS. 1-7E increase the potential of the successful financial operation of a community in conjunction with maintaining the amicability of interpersonal relationships within the community by making each member of the community a direct stakeholder in the finances of the community. In effect, the method encourages the community to act as a unit with the motivation being a loss of goods/services if one or more of the members of the community does not participate according to the operation provided by the method. Conversely, if a community has reason to distrust an individual that manages the finances of a community, the method removes the financial responsibility from the one person to thereby reduce the likelihood of the person embezzling funds from the group. Accordingly, the method described in FIGS. 1-7E, in effect, provides a “virtual treasurer” that provides many benefits to a community having to manage shared bills/expenses.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A method (400, 600) for financing community expenses, comprising the steps of:
providing (S.408, S.509, S.609) to a virtual treasurer (100) one or more amounts to be paid to one or more payees (46); and
requesting (S.410, S.512, S.615) that the virtual treasurer (100) move a designated amount of funds from a fund account (112a-112c) of each member (102a-102c) of a community (102) to the one or more payees (46).

2. The method (400, 600) according to claim 1, wherein the one or more amounts to be paid are community expenses (106) for goods/services that are sharably-consumed by the members (102a-102c) of the community (102).

3. The method (400, 600) according to claim 2 further comprising the step of registering (S.406, S.606), with the virtual treasurer (100), user-defined payment variable(s) related to a proportional amount of the good/services that is/are sharably-consumed by one or more designated member(s) (102a-102c) of the community (102).

4. The method (400, 600) according to claim 1, wherein one or more of the fund accounts (112a-112c) is funded by a third party (108) that funds the community expenses (106) of one or more of the members (102a-102c).

5. The method (400, 600) according to claim 1 further comprising the step of registering (S.403, S.603), with the virtual treasurer (100), usernames, passwords, and email addresses associated with each member (102a-102c) of the community (102).

6. The method (400, 600) according to claim 1 further comprising the step of registering (S.404, S.604), with the virtual treasurer (100), fund accounts (112a-112c) associated with each member (102a-102c) of the community (102).

7. The method (400, 600) according to claim 1 further comprising the step of registering (S.405, S.605), with the virtual treasurer (100), payee account(s) of the payee(s) (46).

8. The method (400, 600) according to claim 1, wherein, after the requesting step (S.410), if the designated amount of funds from a fund account (112a-112c) of each member (102a-102c) is available, authorizing (S.412, S.617) the virtual treasurer (100) to pay the one or more payee(s) (46) with funds from the fund account (112a-112c) of each member (102a-102c).

9. The method (400, 600) according to claim 8, wherein, after the authorizing step (S.412, S.617), providing a notice (S.412, S.618) to the members (102a-102c) that the one or more payee(s) (46) were paid.

10. The method (400, 600) according to claim 8, wherein, after the authorizing step (S.412, S.617), providing (S.414, S.619) a payment summary report and/or charging a service fee for brokering the transaction with the virtual treasurer (100).

11. The method (600) according to claim 1, wherein, prior to the requesting step (S.615), moving funds (S.608) from the fund account (112a-112c) of each member (102a-102c) of the community (102) to a community expense deposit account of the virtual treasurer (100).

12. The method (600) according to claim 11, wherein, if adequate funds are not available in the community expense deposit account (S.611, S.612), saving (S.613) the one or more amounts to be paid to one or more payees (46), and preventing (S.614) said requesting step (S.615) to occur.

13. The method (600) according to claim 11, wherein, if adequate funds are available in the community expense deposit account (S.611), allowing said requesting step (S.615) to occur, and, if the designated amount of funds from the fund account (112a-112c) of each member (102a-102c) is not available (S.616), determining (S.620) if the designated amount of funds from the fund account (112a-112c) is available in the community expense deposit account.

14. The method (600) according to claim 13, if the designated amount of funds from the fund account (112a-112c) is not available in the community expense deposit account (S.620), sending (S.621) a notice to the members (102a-102c) that inadequate funds are in the fund accounts (112a-112c) and community expense deposit account, placing (S.622) a hold on the request step (S.615) and saving the one or more amounts to be paid to one or more payees (46), and preventing said requesting step (S.615) to occur.

15. The method (600) according to claim 13, if the designated amount of funds from the fund account (112a-112c) is available in the community expense deposit account (S.620), drawing (S.624) the designated amount of funds from the community expense deposit account, providing (S.625) a payment summary report, notice to the members (102a-102c) of the lack of available funds in the fund account (112a-112c), and/or charge for brokering the transaction with the virtual treasurer (100).

16. A method (500) for financing community expenses, comprising the steps of:
moving (S.508) funds from a fund account (112a-112c) of each member (102a-102c) of a community (102) to a community expense deposit account of a virtual treasurer (100);
providing (S.509) to the virtual treasurer (100) one or more amounts to be paid to one or more payees (46); and
requesting (S.512) that the virtual treasurer (100) move a designated amount of funds from the community expense deposit account to the one or more payees (46).

17. The method (500) according to claim 16, wherein the one or more amounts to be paid are community expenses (106) for goods/services that are sharably-consumed by the members (102a-102c) of the community (102).

18. The method (500) according to claim 17 further comprising the step of registering (S.506), with the virtual treasurer (100), user-defined payment variable(s) related to a proportional amount of the good/services that is/are sharably-consumed by one or more designated member(s) (102a-102c) of the community (102).

19. The method (500) according to claim 16, wherein one or more of the fund accounts (112a-112c) is funded by a third party (108) that funds the community expenses (106) of one or more of the members (102a-102c).

20. The method (500) according to claim 16 further comprising the step of registering (S.503), with the virtual treasurer (100), usernames, passwords, and email addresses associated with each member (102a-102c) of the community (102).

21. The method (500) according to claim 16 further comprising the step of registering (S.504), with the virtual treasurer (100), fund accounts (112a-112c) associated with each member (102a-102c) of the community (102).

22. The method (500) according to claim 16 further comprising the step of registering (S.505), with the virtual treasurer (100), payee account(s) of the payee(s) (46).

23. The method (500) according to claim 16, wherein, if adequate funds are not available in the community expense deposit account (S.51 1), providing a notice to each member (102a-102c, 108) that adequate funds are not available and saving (S.515) the one or more amounts to be paid to one or more payees (46), and preventing said requesting step (S.512) to occur.

23. An apparatus for financing community expenses, comprising:
a payee end (16) including one or more payee fund accounts (44);
a community end (12) including one or more fund accounts (26) of each member (28) of a community (30); and
a provider end (14) that moves a designated amount of funds from the one or more fund accounts (26) of each member (28) of the community (30) to the one or more payee fund accounts (44) of one or more payees (46).

24. The apparatus according to claim 23, wherein the provider end (14) moves the designated amount of funds electronically over the Internet (18).

25. The apparatus according to claim 23, wherein the provider end includes a virtual treasurer (100), wherein the virtual treasurer (100) includes an Internet server (34) and/or database (36) that utilizes information registered by or on behalf of each member (28).

26. The apparatus according to claim 25, wherein the registered information includes user-defined payment variable(s) related to a proportional amount of the good/services that is/are sharably-consumed by one or more designated member(s) (28) of the community (30).

27. The apparatus according to claim 25, wherein the registered information includes usernames, passwords, and email addresses associated with each member (28) of the community (30).

28. The apparatus according to claim 25, wherein the registered information includes the one or more fund accounts (26) associated with each member (28) of the community (30).

29. The apparatus according to claim 25, wherein the registered information includes the one or more payee fund accounts (44).

30. The apparatus according to claim 23, wherein the community end (12) includes one or more fund accounts (26) associated with one or more third parties (108) that funds the community expenses (106) of one or more of the members (28).

31. The apparatus according to claim 23, wherein the provider end (14) includes a call center (40) for verbally assisting the movement of funds to the members (28) or payee(s) (46).
